(19) United States
(12) Patent Application Publication
(10) Pub. No.: US 2015/0091515 A1
(43) Pub. Date: Apr. 2, 2015

(54) CIRCUIT FOR WIRELESS ENERGY-TRANSFER BY WAY OF AN ALTERNATING MAGNETIC FIELD, AND ELECTRICALLY POWERED VEHICLE

(71) Applicant: SIEMENS AKTIENGESELLSCHAFT, MUENCHEN (DE)

(72) Inventors: MANUEL BLUM, OTTOBRUNN (DE); THOMAS KOMMA, OTTOBRUNN (DE); MIRJAM MANTEL, MUENCHEN (DE); MONIKA POEBL, MUENCHEN (DE)

(21) Appl. No.: 14/499,419

(22) Filed: Sep. 29, 2014

(30) Foreign Application Priority Data
Sep. 27, 2013 (DE) 102013219533.8

(51) Int. Cl. B60L 11/18; H02J 5/00

(52) U.S. Cl. CPC B60L 11/182; H02J 5/005
USPC 320/108; 307/104

(57) ABSTRACT

The invention relates to a circuit arrangement for a wireless energy-transferring coupling by means of an alternating magnetic field, having a coil circuit with at least one electronic coil for providing the wireless energy-transferring coupling with an external coil circuit and a converter which can be connected to an electrical energy source and/or an electrical energy sink for supplying the coil circuit with electrical energy from the electrical energy source or for conducting away electrical energy from the coil circuit to the electrical energy sink, wherein the coil circuit is connected to the converter. With the invention, it is proposed that a winding of the electronic coil is dimensioned, with regard to the geometry and winding count thereof, such that a broadest possible range can be achieved for a compensation.

### CROSS-REFERENCE TO RELATED APPLICATION

This application claims the priority, under 35 U.S.C. §119, of German patent application DE 10 2013 219 533.8, filed Sep. 27, 2013; the prior application is herewith incorporated by reference in its entirety.

### BACKGROUND OF THE INVENTION

### Field of the Invention

The present invention relates to a circuit arrangement for a wireless energy-transferring coupling by way of an alternating magnetic field, having a coil circuit with at least one electronic coil for providing the wireless energy-transferring coupling with an external coil circuit and a converter which can be connected to an electrical energy source and/or an electrical energy sink for supplying the coil circuit with electrical energy from the electrical energy source or for conducting away electrical energy from the coil circuit to the electrical energy sink, wherein the coil circuit is connected to the converter. The invention further relates to an electrically powered vehicle having a drive apparatus which comprises an electric machine, an electrical energy storage device for supplying the electric machine with electrical energy during drive operation of the vehicle, and a charging device for feeding electrical energy to the electrical energy storage device, for which purpose the charging device comprises a circuit arrangement for a wireless energy-transferring coupling by means of an alternating magnetic field, said circuit arrangement having a coil circuit with at least one electronic coil for providing the wireless energy-transferring coupling with an external coil circuit and a converter which is connected to the electrical energy source for conducting away electrical energy from the coil circuit to the electrical energy storage device, wherein the coil circuit is connected to the converter.

Vehicles of the generic type with a charging device for the wireless transfer of energy by way of an alternating magnetic field are per se known, so that no special written disclosure thereof is required. The electrically powered vehicle has the charging device so that energy can be fed to the electrically powered vehicle, said energy preferably being stored in an energy storage device of the vehicle for the purpose of carrying out the intended operation, specifically drive operation. The energy is typically provided by means of a charging station which itself is connected to an electrical energy source, for example, a public energy supply network, to an electric generator, a battery and/or the like. The charging station generates the alternating magnetic field while receiving electrical energy from the electrical energy source. The charging device of the vehicle detects the alternating magnetic field, absorbs energy therefrom and makes electrical energy available to the vehicle, particularly in order to supply the electrical energy storage device of the vehicle and/or the electric machine of the drive apparatus with electrical energy.

One possibility for feeding the energy from the charging station to the charging device of the vehicle consists therein that an electrical connection is created as an energy-transferring coupling by means of a cable between the vehicle and the charging station. According to a further possibility, it is also known to create a wireless energy-transferring coupling which avoids a complex mechanical connection by means of a cable. For this purpose, in general, provided on each of the charging station side and the vehicle side is a coil circuit, said circuits being arranged essentially opposing one another during a charging process and enabling an energy-transferring coupling, making use of an alternating magnetic field. Such an arrangement is described, for example, in Korean published patent application KR 10 2012 0 016 521 A.

In systems wherein energy is transferred by way of an alternating magnetic field, also known as inductive energy transfer, the inductances of the coil circuits involved can be substantially changed by varying the distance and/or an offset. In known systems, this results in a substantial change in the operating frequency, that is, the frequency of the alternating magnetic field. If the parameters of the coil circuit change beyond a comparison value, this results in a lessening of the efficiency so that a pre-determined measured power level can no longer be transferred.

One possibility of adapting the operating frequency is based on the use of variable capacitance diodes in order to achieve frequency tuning. A use of this type of frequency tuning in systems for inductive energy transfer, for example, for the purpose of charging an energy storage device of an electric vehicle is complex to implement. It is achievable only in a limited tuning range. Furthermore, due to the voltages arising and the power levels to be transferred during the intended operation, a complex series and parallel connection of variable capacitance diodes is necessary. In order to be able to counteract the change in the operating frequency occurring during the intended operation, a correspondingly greater circuit complexity is necessary.

Inductive energy transfer suffers from the problem that the power level transferable and the efficiency are dependent on an air gap between the charging station and the electrically powered vehicle, as well as on an offset range. With a pre-determined system design, a satisfactory operation as intended can therefore only be achieved within a small air gap range as well as a narrow load and offset range. The power transferred can only be set by means of a change in the operating frequency. However, this measure is usable only to a very limited extent on account of normative limits and pre-conditions.

For the purpose of compensation, it is therefore provided in the prior art that compensating circuits are connected between the converter and the coil arrangements. The compensating circuits are able to compensate for the electrical reactive voltages with the aid of capacitors. These circuits can be provided both on the primary side and on the secondary side. In practical operation, it has been found that sufficient compensation cannot be achieved in all operating states with a conventional capacitor-based compensating circuit.

### SUMMARY OF THE INVENTION

It is accordingly an object of the invention to provide a circuit arrangement of the generic type and an electrically powered vehicle which overcome the disadvantages of the heretofore-known devices of this general type and which provide for an improved power transfer based on an inductive transfer system.

With the above and other objects in view there is provided, in accordance with the invention, a circuit arrangement for a wireless energy-transfer coupling by way of an alternating magnetic field, the circuit arrangement comprising:

a coil circuit having at least one electronic coil for providing the wireless energy-transfer coupling with an external coil circuit;

a converter to be connected to one or both of an electrical energy source and an electrical energy sink, for supplying said coil circuit with electrical energy from the electrical energy source or for conducting electrical energy away from said coil circuit to the electrical energy sink, said coil circuit being connected to said converter;

said electronic coil having a winding with a defined geometry and a defined winding count dimensioned to enable a broadest possible range for a compensation.

Electronic coils for wireless energy-transferring coupling or inductive energy-transfer can have different geometries and winding counts on the charging station side and on the vehicle side.

The efficiency of the coils can be determined based on a leakage inductance. The concept of leakage inductance relates to the inductance portion of an electronic coil which is formed in magnetically coupled systems by a “magnetic leakage flux.” The leakage inductance plays a significant role, for example, in the transformer model. The state of the energy-transfer coupling of the charging station with the electrically powered vehicle can be described using the transformer model. The leakage inductance is determined using the same process and methods as any other inductance, except that only the magnetic leakage flux is taken into account.

During the intended operation, operating states can arise in which one or both of the leakage inductances assume the value 0 or even negative values for the inductance. With conventional, capacitor-based compensating circuits, a compensation cannot be achieved in such a case. Rather, a compensating circuit of this type has a further disadvantageous effect on the transferred power.

With regard to the circuit arrangement, the invention proposes, in particular, that a winding of the electronic coil is dimensioned, with regard to the geometry and winding count thereof, such that a broadest possible range can be achieved for a compensation. The invention takes into account that the electronic coil of the coil circuit of the electrically powered vehicle is typically smaller, particularly with regard to the geometry, an inductance value or the like, than the electronic coil of the circuit arrangement of the charging station. This is a result, inter alia, of requirements of the vehicle manufacturers, who wish to have the smallest possible electronic coil in the electrically powered vehicle, preferably having the least possible influence on the structure of the electrically powered vehicle.

In particular, small distances of the coil circuit of the electrically powered vehicle from the coil circuit of the charging station during charging operation can have the effect that the aforementioned leakage inductance takes a negative value on the vehicle side. In this configuration, compensation using capacitors is not achievable. The invention therefore proposes that the compensating circuit has an inductance as a passive electronic energy storage device, by means of which, in this configuration, reliable compensation can be achieved for the largest possible power transfer. The compensating circuit preferably provides that the inductance is connected in series with the electronic coil.

On the charging station side, the converter has at least one converter, in particular an inverter, which converts energy fed from the energy source into an alternating voltage which causes an alternating current in the electronic coil, by means of which the electronic coil generates the alternating magnetic field. On the vehicle side, the converter can be formed by a rectifier, downstream of which a DC/DC converter can also be connected. On the vehicle side, the converter serves to convert the energy extracted with the electronic coil on the vehicle side from the alternating magnetic field into energy suitable for the electrically powered vehicle. The charging station and the electrically powered vehicle form an inductive transfer system with their respective circuit arrangements for the wireless energy-transferring coupling by means of an alternating magnetic field. This system can be described with the aid of an equivalent circuit diagram of a transformer. A particular representation of an equivalent circuit diagram for the inductive transfer system has one primary and one secondary leakage inductance and a mutual inductance. By means of the leakage inductances, reactive voltages are formed which interfere when energy is transferred from the charging station to the electrically powered vehicle, because said voltages reduce the transferable energy.

Inductive energy transfer and wireless energy-transferring coupling in the context of the invention is a coupling for the purpose of the transfer of energy which enables energy to be transferred at least unidirectionally from an energy source to an energy sink. The energy source can be, for example, a public energy supply network, an electric generator, a solar cell, a fuel cell, a battery, combinations thereof and/or the like. The energy sink can be, for example, a drive apparatus of the electrically powered vehicle, in particular an electric machine of the drive apparatus and/or an electric energy storage device of the drive apparatus, for example, an accumulator or the like. However, a bidirectional energy transfer can also be provided, that is, energy transfer alternately in both directions. This purpose is served, inter alia, by the charging station, which is intended to transfer energy to the electrically powered vehicle, for which purpose the charging station draws electrical energy from an energy source to which it is electrically connected.

Wireless energy-transferring coupling or inductive energy transfer in the context of the invention means that no mechanical connection needs to be provided between the charging station and the electrically powered vehicle in order to establish an electrical coupling. In particular, the establishment of an electrical connection by means of a cable can be avoided. In place thereof, the energy-transferring coupling takes place purely on the basis of an energy field, preferably an alternating magnetic field.

The charging station is therefore set up to generate a corresponding energy field, in particular an alternating magnetic field. On the vehicle side, it is provided accordingly that an energy field or an alternating magnetic field of this type can be detected and energy is obtained therefrom for the intended operation of the electrically powered vehicle. By means of the charging device of the vehicle, the energy supplied by means of the energy field, in particular the alternating magnetic field is converted into electrical energy which can then preferably be stored in the energy storage device of the vehicle for the intended operation thereof. For this purpose, the charging device can have a converter which converts the energy extracted from the alternating magnetic field by means of the coil and fed to the converter into electrical energy suitable for the vehicle, for example rectifies or voltage-transforms the energy or the like. Furthermore, the energy can also be fed directly to the electric machine of the drive apparatus of the vehicle. The energy-transferring coupling therefore serves essentially for the transference of energy and not primarily the transference of information. Thus, the means for carrying out the invention are configured for a correspondingly high power throughput, in contrast to a wireless communication connection.

A primarily important element for a wireless energy-transfer coupling, in particular by way of the alternating magnetic field, is a coil circuit which comprises at least one electronic coil, possibly also a plurality of electronic coils which, on the vehicle side, are pervaded by the energy field, in particular the magnetic flux in the case of an alternating magnetic field provided as the energy field, and which supply electrical energy at the corresponding terminals thereof. Accordingly, on the charging station side, an alternating current which brings about an alternating voltage is applied to the coil circuit, so that the coil circuit provides, by means of its coil or coils, an alternating magnetic field, by means of which energy can be output. By means of the alternating magnetic field, the coil circuit of the charging station is coupled with the coil circuit of the electrically powered vehicle during a charging process.

Typically, the coil has a winding with a plurality of windings of an electric conductor wherein the winding typically has a ferromagnetic body which is often made of, or comprises, a ferrite. By means of the ferromagnetic body, the magnetic flux can be guided in the desired manner so that the effectiveness of the energy-transferring coupling due to the alternating magnetic field between the coil circuits of the charging station and of the electrically powered vehicle can be increased.

The electrical conductor forming the windings of the electronic coil is often configured as a high-frequency litz wire, which means that it consists of a large number of individual conductors or wires which are electrically insulated relative to one another and which, accordingly are grouped together to form the conductor. It is thereby achieved that for frequency uses as per the invention, a current-displacement effect is reduced or is largely prevented. In order to achieve the most uniform possible current distribution to the individual strands of the high-frequency litz wire, twisting of the individual strands is also provided. Twisting can also include the formation of bundles from a particular number of individual wires which are twisted within each bundle, wherein said bundles forming the electrical conductors are also twisted.

A further development of the invention provides that the inductance of the compensating circuit is configured to be settable. This can be achieved, for example, by means of a control unit which can preferably be included in the circuit arrangement. For this purpose, the at least one inductance of the compensating circuit is configured to be settable. For example, the inductance can be provided by a series connection of a plurality of inductances which can be activated or deactivated by means of a switching element as needed.

A passive electronic energy storage device is distinguished in that said store generates and/or uses essentially no electrical energy. It is preferably an electronic component such as an inductance, for example a coil, a capacitor or the like. The passive electronic energy storage device serves to influence properties of the coil circuit in a desired pre-definable manner in order to be able to achieve the best possible coupling and/or the highest possible efficiency in the energy coupling. Said energy storage device is therefore, in particular not a galvanic cell, that is, not a battery or an accumulator. The passive electronic energy storage device is therefore to be distinguished from the electrical energy storage device, which can be provided by an accumulator, a battery or the like and essentially serves as part of an electrical energy supply, for example, as an energy source and/or an energy sink.

The inductances can be short-circuited, for example, by means of a switching element associated with them, in order to deactivate their effect. Preferably, this switching element is controllable, particularly by means of the aforementioned control unit. Naturally, a plurality of adjacent windings can be activated or deactivated, in particular short-circuited, by means of a respective switching element.

A switching element within the meaning of this disclosure is preferably a controllable electronic switching element, for example, an electromechanical switching element in the form of a relay, a contactor or the like or, alternatively a controllable electronic semiconductor switch, for example, a transistor, a thyristor, combination circuits therefrom, in particular an anti-parallel connection of two thyristors, an anti-serial connection of two transistors, preferably with parallel-connected freewheeling diodes, a TRIAC, a GTO, IGBT, combinations thereof or the like. Preferably, the switching element is controllable by means of the control unit. The control unit preferably determines the conditions which determine the activation or deactivation of the corresponding part of the multi-part passive electronic energy storage device. For this purpose, the control unit can detect relevant parameters, for example of the converter, of the compensating circuit, of the coil circuit or the like, by means of sensors. Parameters can be, for example, an electric current, an electric voltage, an electric power, a phase shift between an electric voltage and an associated electric current, a local magnetic field strength, an electric power, combinations thereof and/or the like.

According to a further development, the switching element is formed by a semiconductor switching element or a switching unit comprising a plurality of semiconductor switching elements. Preferably, the switching element is configured in order to be able to conduct an electric current in each current direction. A semiconductor switching element can be, as discussed above, a transistor, a thyristor or the like. The switching unit is preferably formed by at least two semiconductor switching elements which are connected in a suitable manner to achieve the intended function. For example, a parallel circuit arrangement of thyristors can be provided which are connected in parallel in opposition with regard to the conducting direction thereof, i.e. anti-parallel. Alternatively, in place of a parallel arrangement of this type, a TRIAC can be used which enables controlled connection in both current-flow directions, as distinct from a single thyristor. The switching unit can comprise, if it has transistors, for example, a series connection of two transistors wherein, in the case of bipolar transistors, the injectors, in the case of MOSFET the corresponding source terminals are electronically connected to one another. The terminals of the switching element thus provided as the switching unit are each formed by the collectors or the drain terminals. In the case of the switching unit with transistors, freewheeling diodes can also be provided. By means of the switching unit or the semiconductor switching element, highly variable, efficient and rapid control or execution of switching processes can be achieved. As compared with an electromechanical switching element, a lower power loss, a higher switching speed and also a higher reliability due to a lower level of wear can be achieved.

As a result, one aspect of the invention is that the compensating circuit has a first switching element by means of which the inductance can be activated. Naturally, the inductance can preferably also be deactivated by means of the switching element.

A further embodiment of the invention provides for the compensating circuit to have a capacitor which can be switched in by means of a second switching element. The capacitor can be provided such that it can be connected in series with the electronic coil of the coil circuit. Furthermore, it can be provided that the capacitor be connected in parallel with the electronic coil. It can also be provided that the capacitor forms a network together with the inductance of the compensating circuit in order to improve further the compensation. This is particularly advantageous if, based on different operating properties at different charging stations, different values for the leakage inductance are produced which with one charging station, can be for example, negative and with another charging station, for example, positive. It is thereby possible to adapt the circuit arrangement to the respective circumstances and to be able to achieve a compensation over a broad operating range.

It has been found to be particularly advantageous if the capacitor is configured to be settable. For this purpose, the capacitor can be made from a plurality of individual capacitors, each of which can be activated or deactivated by means of dedicated switching elements associated therewith. By this means, the setting range of the compensation can be further improved.

Other features which are considered as characteristic for the invention are set forth in the appended claims.

Although the invention is illustrated and described herein as embodied in wireless energy-transferring coupling by means of an alternating magnetic field, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic illustration of a circuit diagram showing the principle of a wireless energy-transferring coupling of a charging station with an electrically powered vehicle during charging operation without a compensating circuit;

FIG. 2 is a schematic equivalent circuit diagram for the arrangement according to FIG. 1;

FIG. 3 is a schematic equivalent circuit diagram according to FIG. 2 with capacitance-based compensation;

FIG. 4 is a diagrammatic view of an electrically powered vehicle disposed at a charging station; and

FIG. 5 is a schematic view of a charging station according to the invention, illustrating additional detail relative to FIG. 2.

### DETAILED DESCRIPTION OF THE INVENTION

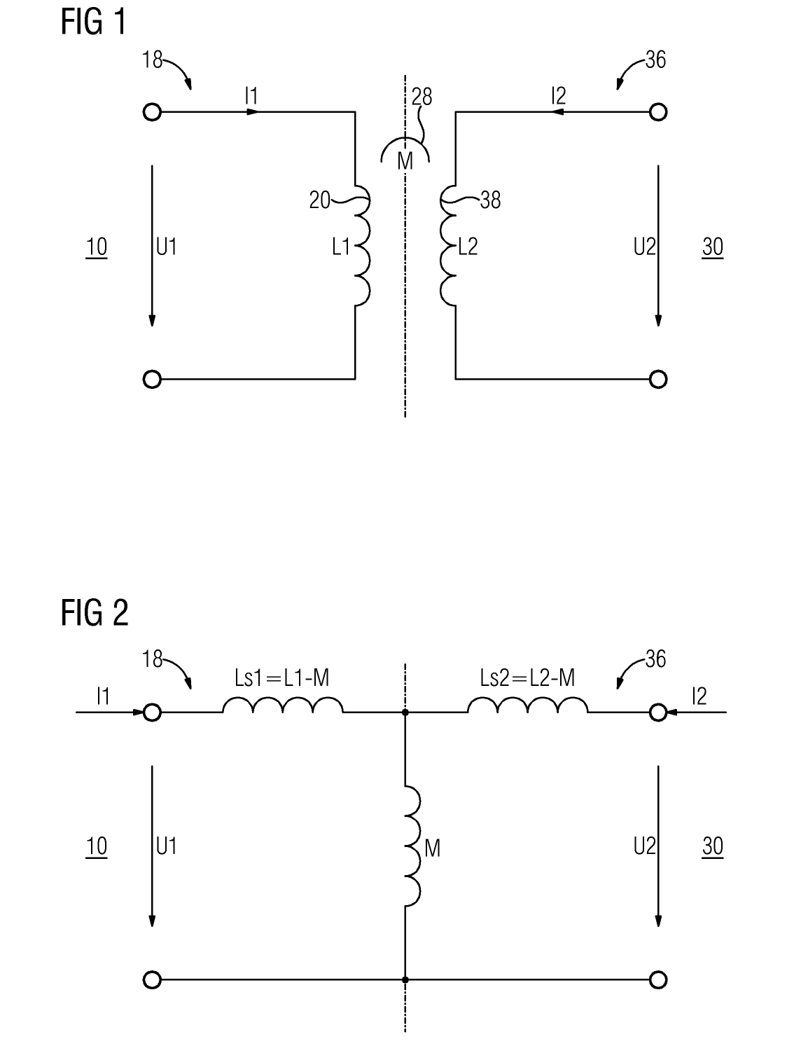

Referring now to the figures of the drawing in detail and first, particularly, to FIG. 1 thereof, there is shown a schematic circuit diagram illustrating a wireless energy-transfer coupling between a circuit arrangement 10 of a charging station and a circuit arrangement 30 of an electrically powered vehicle. The wireless energy-transferring coupling is achieved by means of an alternating magnetic field 28. For this purpose, the circuit arrangement 10 has a coil circuit 18 with an electronic coil 20 to which an alternating voltage U1 is applied from an inverter (not shown in detail), so that an alternating current I1 flows through the electronic coil 20. The magnetic field 28 which serves for inductive energy transfer is generated by way of the alternating current I1.

On the vehicle side, the circuit arrangement 30 has an electronic coil 38 that is subject to, or exposed and pervaded by, the magnetic field 28. Due to the pervasion by the magnetic field 28, the coil 38 generates an alternating electric voltage U2 which is fed to a converter (not shown in detail) which, making use of an alternating current I2, converts the power provided by the coil 38 into power adapted for the electrically powered vehicle. It is apparent from FIG. 1 that compensation is not required.

FIG. 2 shows a corresponding equivalent circuit diagram for the arrangement of FIG. 1 based on the transformer model, from which it is evident that, apart from a coupling inductance M, on the charging station side, a leakage inductance Ls1 and, on the vehicle side, a leakage inductance Ls2 take effect.

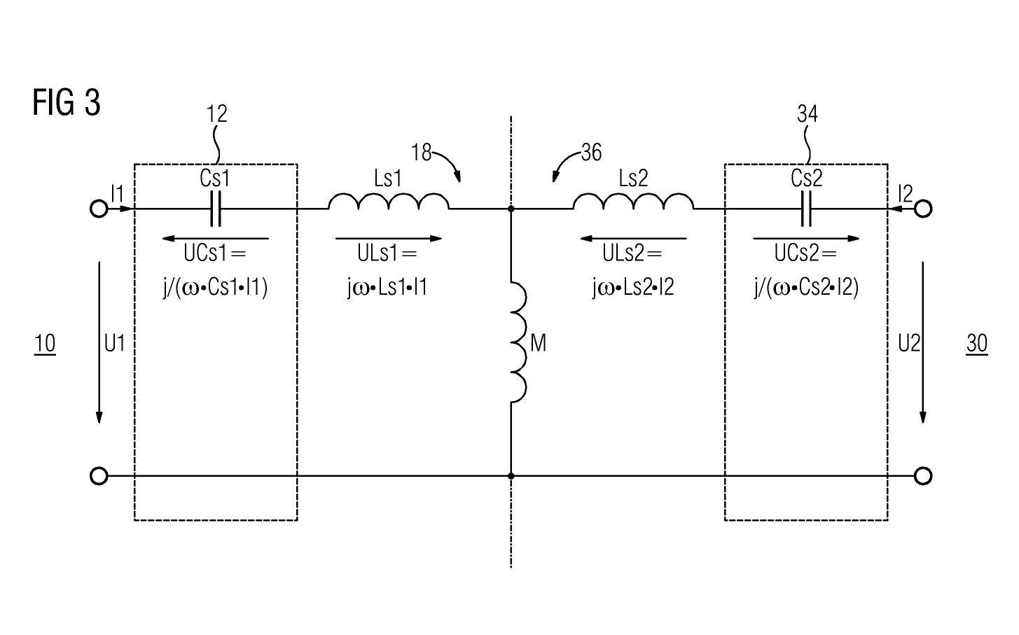

In inductive transfer systems, reactive voltages are produced by means of the parasitic leakage inductances Ls1 and Ls2 which, on the vehicle side, for optimum energy transfer are lacking. In conventional operation (FIG. 3), for the purpose of compensation, there are provided compensating circuits 12, 34 which compensate for the reactive voltages with the aid of capacitors.

The electronic coils 20, 38 for the wireless energy transfer can have different geometries and winding counts on the charging station side and/or on the vehicle side. Considering the representation of FIG. 2, different geometries and winding counts can have the effect, on the charging station side and on the vehicle side, that one of the two inductances Ls1 or Ls2 assumes the value 0 or even negative values. In this case, compensation cannot be achieved by means of a compensating circuit as shown in FIG. 3, but rather the circuit leads to an additional reactive voltage which further restricts the power transfer.

It has conventionally been commonplace to design an inductive transfer system proceeding from the assumption that the leakage inductances Ls1 and Ls2 always have positive values. The reactive voltage drop caused thereby can then be compensated, as shown in FIG. 3, with the compensating circuits 12, 34 which provide that a capacitor Cs1 and Cs2, respectively, is connected in series with each of the leakage inductances Ls1 and Ls2.

If, however, due to the geometric and winding conditions of the inductive transfer system (FIG. 1), a negative leakage inductance Ls1, Ls2 arises (FIG. 2), then the reactive voltage drop caused thereby is added thereto (see also FIG. 3). In this way, the voltage available in the electrically powered vehicle is reduced. Thus, here again, the inductive transfer system operates with a reduced power.

It is provided according to the invention that, by means of specific dimensioning of the geometry and the winding count of the inductive transfer path, the leakage inductance Ls1 or Ls2 assumes a smaller value or the value 0. The conventionally commonplace compensation by way of the compensating circuit 12 or 34 can therefore be dispensed with.

It is provided according to a particular development of the invention that, by means of specific dimensioning of the geometry and the winding count of the inductive transfer path, the leakage inductance Ls1, Ls2 (FIG. 2) assumes a smaller value than 0. In this case, the compensation can be achieved by means of a compensating circuit which comprises an inductance. Preferably, the inductance is connected in series with the respective electronic coil 20, 38.

It has proved to be particularly advantageous if the dimensioning is selected such that the vehicle-side compensating circuit 34 can be dispensed with. This fulfils the requirement of vehicle design to save components and space.

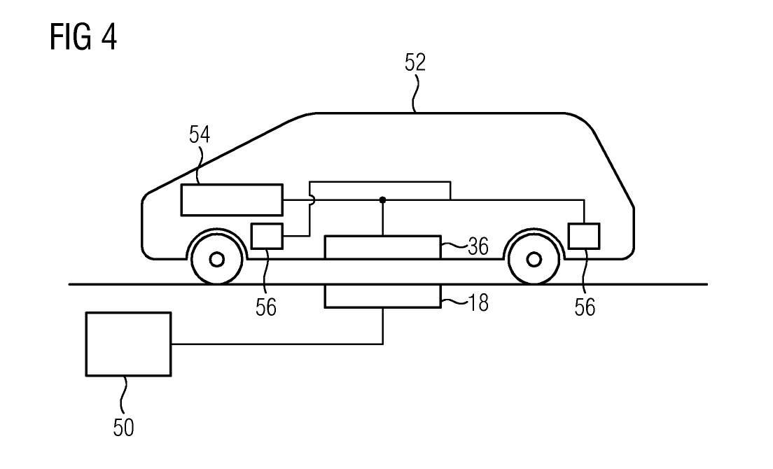

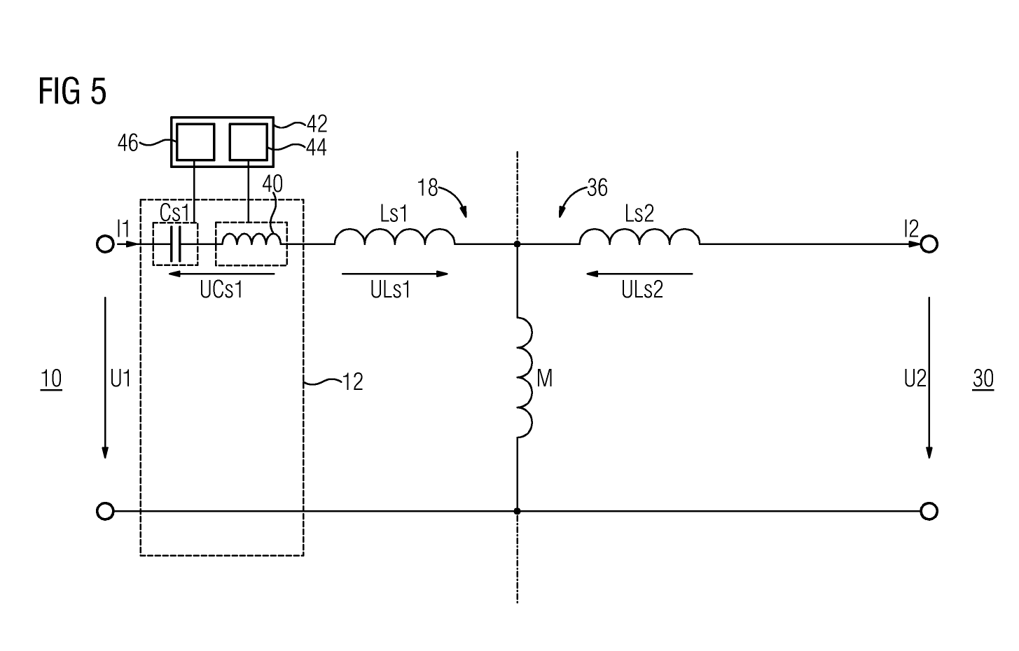

FIG. 4 shows an electrically powered vehicle 52 with a battery 54 and electrical motors 56. Both the battery 54 and the motors 56 represent the energy sink. Also shown is an electrical grid 50 forming the energy source. The elements 36 in the vehicle and 18 underneath the vehicle together form the circuit 10.

FIG. 5 shows an additional adjustable inductance 40 and a control connection to a first switching element 44. The capacitor Cs1 is connected to a second switching element 46 inside a control device 42.

The preceding exemplary embodiment is intended merely to illustrate and not to restrict the invention. Naturally, a person skilled in the art would provide suitable variations as needed without departing from the central concepts of the invention.

Naturally, individual features can be combined with one another in any required manner as needed. Furthermore, device features can naturally also be disclosed through corresponding method steps and vice versa.

1. A circuit arrangement for a wireless energy-transfer coupling by way of an alternating magnetic field, the circuit arrangement comprising:
a coil circuit having at least one electronic coil for providing the wireless energy-transfer coupling with an external coil circuit;
a converter to be connected to one or both of an electrical energy source and an electrical energy sink, for supplying said coil circuit with electrical energy from the electrical energy source or for conducting electrical energy away from said coil circuit to the electrical energy sink, said coil circuit being connected to said converter;
said electronic coil having a winding with a defined geometry and a defined winding count dimensioned to enable a broadest possible range for a compensation.

2. The circuit arrangement according to claim 1, which comprises a compensating circuit with an inductance forming a passive electronic energy storage device.

3. The circuit arrangement according to claim 2, wherein said inductance of said compensating circuit is an adjustable inductance.

4. The circuit arrangement according to claim 2, wherein said compensating circuit comprises a first switching element configured to enable said inductance to be activated and a capacitor to be switched in by way of a second switching element.

5. The circuit arrangement according to claim 2, wherein said compensating circuit comprises a switching element configured to enable said inductance to be activated.

6. The circuit arrangement according to claim 2, wherein said compensating circuit comprises a capacitor to be switched in by way of a switching element.

7. The circuit arrangement according to claim 6, wherein said capacitor is an adjustable capacitor.

8. An electrically powered vehicle, comprising:
a drive apparatus including an electric machine and an electrical energy storage device for supplying the electric machine with electrical energy during drive operation of the vehicle;
a charging device for feeding electrical energy to said electrical energy storage device, said charging device including a circuit arrangement for a wireless energy-transfer coupling via an alternating magnetic field;
said circuit arrangement of said charging device having a coil circuit with at least one electronic coil for providing the wireless energy-transfer coupling with an external coil circuit and a converter connected to said electrical energy source for conducting electrical energy from said coil circuit to said electrical energy storage device;
wherein said coil circuit is connected to said converter.

9. An electrically powered vehicle, comprising:
a drive apparatus including an electric machine and an electrical energy storage device for supplying the electric machine with electrical energy during drive operation of the vehicle;
a charging device for feeding electrical energy to said electrical energy storage device, said charging device including a circuit arrangement according to claim 1.
